(19) United States
(12) Patent Application Publication
(10) Pub. No.: US 2021/0044782 A1
(43) Pub. Date: Feb. 11, 2021

(54) MOBILE SURVEILLANCE SYSTEM

(71) Applicant: James Clack, Sicklerville, NJ (US)

(72) Inventor: James Clack, Sicklerville, NJ (US)

(21) Appl. No.: 16/989,313

(22) Filed: Aug. 10, 2020

Related U.S. Application Data
(60) Provisional application No. 62/884,798, filed on Aug. 9, 2019.

(51) Int. Cl. H04N 7/18; H04N 5/225; H04N 5/232; B60R 25/30; B60R 25/10; B60R 25/40

(52) U.S. Cl. CPC H04N 7/188; H04N 5/2256; H04N 5/23238; H04N 5/2253; B60R 25/1004; B60R 25/403; B60R 25/305

(57) ABSTRACT

A mobile surveillance system includes a plurality of cameras affixed to a motor vehicle collectively providing a complete set of views around the motor vehicle, a recording device and a monitoring device for viewing images.

### CROSS-REFERENCE TO RELATED APPLICATION

The present application claims the priority of U.S. Provisional Patent Application 62/884,798, filed Aug. 9, 2019, which is incorporated herein by reference.

### BACKGROUND OF THE INVENTION

### 1. Field of the Invention

The present invention relates to surveillance systems.

### 2. Brief Description of the Prior Art

Home and business premises surveillance systems are known. Such systems typically include a video camera connected to a monitoring device such as a personal computer. Images from the video camera can be recorded and later played back to provide information relating to incidents occurring within the camera's field of view. As digital data storage capacities have increased, larger and larger data files can be stored and retrieved. The stored information can include video recordings. The data from individual surveillance systems can be shared, such as with a group of neighbors allowing private neighborhood security networks. Home and business premises security systems can require a significant expenditure including both the cost of the physical equipment and the labor of physical installation and of installing software and establishing electronic connections, thus limiting systems to fixed installation sites such as homes, stores, and office.

Specialized camera systems for motor vehicles are known, such as rear view camera for use during backing up the vehicles, as well as cameras for use in systems that sense environmental conditions and automatically alter vehicle control (e.g. emergency braking for crash avoidance).

There were about six million motor vehicle accidents in 2019 in the United States, resulting enormous property damage and personal injury. Often, it is difficult to determine whether either party to a motor vehicle accident is at fault, and the extent of their fault in causing the accident, as the recollections of the involved individuals and third party witnesses differ significantly.

### SUMMARY OF THE INVENTION

In one aspect, the present invention provides a mobile surveillance system for a motor vehicle such as a truck or a passenger car. In this aspect, the system comprises a motor vehicle and a plurality of cameras affixed to the motor vehicle. The plurality of cameras collectively provides a set of views around the motor vehicle. Each of the plurality of camera providing a respective image, The system further includes in this aspect at least one image recording device for recording images provided by at least one of the plurality of cameras. In addition, in this aspect, the system preferably includes at least one monitoring device for viewing images recorded by the image recording device. Preferably, the image recording device is adapted to record video. Preferably, the system includes an electrical power source for powering at least one of the plurality of cameras and the at least one image recording device. Preferably, the electrical power source includes an inverter for converting direct current generated by the motor vehicle's alternator to alternating current for powering the at least one of the plurality of cameras and the at least one image recording device. Preferably, the set of views collectively provide a complete view 360 degrees around the motor vehicle. Preferably, the set of views is continuously provided to at least one monitoring device. Preferably, the mobile surveillance system further includes means for controlling the operation of at least one of the plurality of cameras and the at least one image recording device. In one aspect of the present invention, the motor vehicle comprises a semi-trailer truck and a trailer. Preferably, the mobile surveillance system further includes at least one motion detection device for detecting motion within the field of at least one of the plurality of cameras and generating a signal in response to the detected motion. The signal activates operation of a respective camera and the at least one image recording device. In one aspect the means for controlling the operation of the cameras comprises a timing device. Preferably, the at least one image recording device can simultaneously record images from at least two of the plurality of cameras. Preferably, the at least one image recording device can simultaneously record video from at least two of the plurality of cameras. Preferably, the mobile surveillance system further includes a transmitter for transmitting information relating to images generated by the plurality of cameras to be received by a remote device for remotely monitoring the environment of the motor vehicle. Preferably, the transmitter transmits images generated by the plurality of cameras. Preferably, the information transmitted includes alarm notifications. In yet another aspect, the mobile surveillance system further includes illumination means for illuminating the field of the at least one camera. Preferably, the illumination means provides infrared radiation and the at least one camera is sensitive to infrared radiation.

The present invention also provides a method of providing mobile surveillance. Preferably, the method comprises providing a motor vehicle with a plurality of cameras, and providing at least one recording device for recording a stream of images from at least one of the plurality of cameras. Preferably, the method includes monitoring the stream of images. Preferably, the method also includes selecting a portion of the recorded stream of images responsive to a notification. Preferably, the method comprises transmitting the selected portion of the recorded stream of images to a third party. Preferably, the stream of images monitored is a recorded stream of images.

The present invention also provides a mobile surveillance system for use with a motor vehicle. In this aspect, the system comprises providing a plurality of cameras to be affixed to the motor vehicle, the plurality of cameras collectively providing a set of views around the motor vehicle, each of the plurality of camera providing a respective image, Preferably, the system further provides at least one image recording device for recording images provided by at least one of the plurality of cameras; and preferably, at least one monitoring device for viewing images recorded by the image recording device.

### DETAILED DESCRIPTION

The present invention provides a mobile surveillance system for a motor vehicle such as a truck or a passenger car, and in particular for tractor-trailers. In one aspect, the mobile surveillance system provides 360 degree camera surveillance around vehicle. The mobile surveillance system advantageously provides vehicle security, protection, and an accurate record of the environment of the vehicle. In one aspect, the present system preferably employs mobile digital video recorders (“DVR”) as well as cameras, and in particular digital video cameras that are connectable to the digital video records. The cameras are preferably placed strategically around a motor vehicle, such as a truck. Preferably, at least four cameras, more preferably six, and still more preferably eight or twelve are positioned around a truck and/or tractor trailer in implementing the present mobile surveillance system, preferably to provide a complete 360 degrees view of the environment of the vehicle. The number and placement of the cameras depend upon a number of factors including, for example, the nature and physical dimensions of the vehicle, and the field of view of the cameras, as well as the positions available for mounting the cameras on the vehicle and the mounting equipment used to mount the cameras on the vehicle. In another aspect of the present mobile surveillance system one or more cameras are placed inside the vehicle to monitor, for example, the interior of the vehicle cab in the case of a truck or tractor trailer, or the interior of a trailer, in the case of a tractor trailer. The orientation of the cameras in relation to the vehicle can be fixed or variable, and the variable position can be adjustable as by motor-driven mounting equipment, such that the orientation of the camera can be controlled remotely. In one aspect, the orientation of the cameras is variable, and is directed by results of an analysis of the images being transmitted from the camera. Similarly, the focus of the camera can be fixed or variable, and in one aspect the focus of a variable focus camera can be controlled remotely.

Preferably, the mobile DVR employed in the mobile communication system has an IMEI (International Mobile Equipment Identity) number and an MEID (Mobile Equipment Identifier) number, to facilitate later communication and processing of video images from the mobile DVR.

The mobile surveillance system provides several important advantages. For example, should the motor vehicle be involved in an accident, there can be a video record of the exterior environment and the interior of the motor vehicle, thus showing how damage to the vehicle occurred.

When tractor trailers are equipped with the mobile surveillance system of the present invention, unexplained cargo shortages, damages, or losses can be avoided.

Preferably, all cameras can be viewed on the monitor inside of the motor vehicle.

Advantageously, motor vehicle-related insurance claims can be made and settled without waiting for a police report concerning the incident giving rise to the insurance clams.

In one aspect of the present invention, digital video images generated by the cameras of the mobile surveillance system are transmitted to a remote monitoring site where the digital video images can be recorded, using a suitable electronic transmission system. For example, the digital video images can be transmitted via a wireless or other connection over the Internet or a private network to a remote monitoring site. Preferably, digital video images can be viewed at the remote site and rapidly retransmitted on request, such immediately (such as within five to ten minutes) after the occurrence of an accident involving the motor vehicle equipped with the mobile surveillance system of the present invention.

Preferably, the mobile surveillance system also includes means for analyzing digital images to extract text information, such as motor vehicle license tag information. Thus, the present invention provides the ability to monitor and identify other motor vehicles in the physical environment of the motor vehicle equipped with a system according to the present invention. The additional information can aid in assigning fault it he case of an accident involving a motor vehicle equipped with a mobile surveillance system of the present invention.

in one aspect of the mobile surveillance system, when the motor vehicle is turned on, the cameras automatically come on and are immediately viewable on an monitor visible to the driver of the vehicle. Preferably, the monitor gives the driver a live 360 degree view of images from all the cameras affixed to the motor vehicle.

Preferably, the image recording device, such as a mobile digital video recorder, includes image storage means such as one or more replaceable storage cards, such SD cards, SDHC cards, and SCXC cards. The storage provision allows the motor vehicle operator to record all cameras simultaneously while driving or idling.

The mobile surveillance system of the present invention is preferably operated continuously, 24 hours a day, seven days a week.

Preferably, I one aspect the cameras employed in the system of the present invention are provided with illumination sources, such as infrared light emitting diodes, as well as image sensors that are sensitive to reflected infrared radiation, so that the cameras can be employed under conditions of low exterior illumination, such in the evening, at night, or when the vehicles is garaged. This allows persons, places, or things at night to be recorded and later identified. At night, when the motor vehicle is parked, the mobile surveillance system can still be employed to provide a record of the motor vehicle environment and provide security.

Preferably, in one aspect, a dedicated power source, such as a dedicated battery, is provided for the image recording device, and/or other components of the mobile surveillance system. In another aspect, the operator of the motor vehicle can choose to power the mobile surveillance system using electrical power derived from the vehicle electrical system, or from a separate electrical power device, such as a separate battery.

In another aspect of the present invention, images from the cameras of the mobile surveillance device are transmitted from the mobile surveillance device to a remote device for monitoring and/or storing the images. For example, images can be transmitted in real time (i.e. “live streamed”) via a wireless transmission device and received and displayed on an IPhone or Android smartphone provided with a suitable app. Further, preferably the images being monitored and/or stored remotely can then preferably be retransmitted to other devices, such as through an Internet protocol. When multiple motor vehicles are equipped with a mobile surveillance system of the present invention, in one aspect, images from each of the motor vehicles so equipped can be transmitted to a central location, so that the environment of each of the motor vehicles can be monitored. In addition to the transmission of camera images, the mobile surveillance system can preferably monitor and transmit other information, such as the physical location of the motor vehicle using GPS monitoring, thus providing the ability to track the vehicle location. Additional capabilities preferably provided by the mobile surveillance system include voice and/or text transmission and reception. This capability allows “base” to communicate to a trucker live while in route. The truck can be watched live by a dispatcher at any given time. Preferably, the system can employ a telecommunication device, such as a smart phone, for remote communication. Preferably, the smart phones includes a SIM card and has at least 4G capability, and is compatible with any major carrier such as AT&T, Verizon, Boost Mobile, T-Mobile, and Sprint.

In one aspect, a mobile DVR is powered by an external battery. For example, a Deep Cycle Marine battery can be employed to power the mobile DVR. Marine batteries can have the capability to power the system all night without any damage to the vehicle or to the video footage.

In another aspect, the mobile surveillance system is provided with a dual battery isolation system and a dual ignition isolator system. In this aspect, the dual battery isolation system and the dual ignition system is provided with an ignition wire running from the ignition switch the mobile DVR, and then from the battery to the switch, to the isolator, back to the Mobile DVR. The ignition switch turns the motor vehicle on. However, a second switch is provided which acts as second ignition system. An electrical isolator is provided between the automobile electrical system and the second switch. This ensures the system with the added second switch does not feed back to the ignition. Otherwise, if the second switch were wired directly to the ignition, there would have been damaging back feed. The additional power supply wiring preferably employ sixteen gauge wire and a pair of diodes from the battery system to the switch to create the ignition isolator.

When a dedicated battery is employed, the battery is preferably selected so that it and be mounted anywhere in the motor vehicle where it can be accessible. Similarly, control means such as switches for turning on and off the mobile communication system can also be placed anywhere in a vehicle as long as they are accessible. Preferably, the dedicated battery is a twelve volt battery.

The mobile surveillance system provides a number of important advantages. For example, the infrared cameras employed can help decrease motor vehicle vandalism and theft. Further, the using the mobile surveillance system, any activity in a person's neighborhood surrounding their car can be monitored and recorded. Unlike most alarm systems there is no need for confrontation, an individual remotely observing vandalism or criminal activity can simply appeal to the local authorities and may available the relevant video footage. The mobile surveillance system can be used during the day time hours when the vehicle is not in use, and provide security around a workplace where the motor vehicle is parked. Similarly, the system can be used to monitor and identify individuals causing accidental damage to motor vehicles, such as when a careless individual opens their car door and causes a dent in an adjaced parked car. The mobile surveillance system can be used when taking the vehicle to be serviced. A owner can view the individual who is doing the work on their vehicle, whether the vehicle is at the mechanic or at an auto body shop. The mobile surveillance system can also help address societal problems such as crime. Widespread adoption of the mobile surveillance system would help identify, track and locate criminal perpetrators. Similarly, the location and environment of physically impaired motor vehicle operators, such as Alzheimer sufferers could be monitored. Similarly, drivers lacking maturity and experience, such as teenage drivers, could be remotely monitored using the mobile surveillance system of the present invention, giving information as their location, with whom they are travelling, etc., thus increasing the safety and security of the drivers.

Unlike tracking devices, the mobile surveillance system can provide 360 degrees of video footage in and/or around the vehicle along with tracking, thus tending to reduce carjacking and auto theft, discouraging auto theft, human trafficking, and false insurance claims. Similarly, the mobile surveillance system can help in locating missing persons.

### EXAMPLE

A mobile surveillance system of the present invention was installed in a truck, using an inverter and providing cameras to give the truck with 360 degree surveillance.

Shortly after installing these cameras, the truck was involved in an accident on the George Washington Bridge. This accident involved one of the workers that worked on the bridge. While driving over the bridge, the worker came up beside the truck in his vehicle on my right side and tore off the truck mirror and the right quarter fender.

According to the workers and the police officer on duty, the truck operator was at fault.

Knowing that the mobile surveillance system provided the opportunity to review the incident on a monitor in the truck, the truck driver requested that the officer to come and review the video footage of the accident. After the officer reviewed the incident on the monitor his whole demeanor changed.

Later when the truck driver tried to turn in the police report to his insurance company to prove that he was not at fault, the insurance company refused to believe the report and said both the truck driver and the worker were both at fault. In order to prove he was not at fault, the truck driver permitted the insurance company the video of the accident. After reviewing the video, the insurance company understood that there was nothing that the truck drive did or could have prevented to keep the accident from occurring, and, at the end of the day, the insurance company paid for all the damages.

Various modifications can be made in the details of the various embodiments of the processes and system of the present invention, all within the scope and spirit of the invention as defined by the appended claims.

1. A mobile surveillance system comprising:
a) a motor vehicle,
b) a plurality of cameras affixed to the motor vehicle, the plurality of cameras collectively providing a set of views around the motor vehicle, each of the plurality of cameras providing a respective image,
c) at least one image recording device for recording images provided by at least one of the plurality of cameras; and
d) at least one monitoring device for viewing images provided by the cameras including images recorded by the image recording device.

2. A mobile surveillance system according to claim 1 wherein the image recording device is adapted to record video.

3. A mobile surveillance system according to claim 1 further including an electrical power source for powering at least one of the plurality of cameras and the at least one image recording device.

4. A mobile surveillance system according to claim 3 wherein the electrical power source includes an inverter for converting direct current generated by the motor vehicle's alternator to alternating current for powering the at least one of the plurality of cameras and the at least one image recording device.

5. A motor vehicle according to claim 1 wherein the set of views collectively provides a complete view 360 degrees around the motor vehicle.

6. A mobile surveillance system according to claim 1 further including means for controlling the operation of at least one of the plurality of cameras and the at least one image recording device.

7. A mobile surveillance system according to claim 1 wherein the motor vehicle comprises a semi-trailer truck and a trailer.

8. A mobile surveillance system according to claim 1 further including at least one motion detection device for detecting motion within the field of at least one of the plurality of cameras and generating a signal in response to the detected motion, the signal activating operation of a respective camera and the at least one image recording device.

9. A mobile surveillance system according to claim 6 wherein the means for controlling comprises a timing device.

10. A mobile surveillance system according to claim 1 wherein the at least one image recording device can simultaneously record images from at least two of the plurality of cameras.

11. A mobile surveillance system according to claim 1 wherein the at least one image recording device can simultaneously record video from at least two of the plurality of cameras.

12. A mobile surveillance system according to claim 1 further including a transmitter for transmitting information relating to images generated by the plurality of cameras to be received by a remote device for remotely monitoring the environment of the motor vehicle.

13. A mobile surveillance system according to claim 12 wherein the transmitter transmits images generated by the plurality of cameras.

14. A mobile surveillance system according to claim 12 wherein the information transmitted includes alarm notifications.

15. A mobile surveillance system according to claim 1 further including illumination means for illuminating the field of the at least one camera.

16. A mobile surveillance system according to claim 15 wherein the illumination means provides infrared radiation and the at least one camera is sensitive to infrared radiation.

17. A method of providing mobile surveillance, the method comprising:
a) providing a motor vehicle with a plurality of cameras;
b) providing at least one recording device for recording a stream of images from at least one of the plurality of cameras,
c) monitoring the stream of images,
d) selecting a portion of the recorded stream of images responsive to a notification.

18. A method according to claim 17 further comprising transmitting the selected portion of the recorded stream of images to a third party.

19. A method according to claim 17 wherein the stream of images monitored is a recorded stream of images.

20. A mobile surveillance system for use with a motor vehicle, the system comprising:
a) a plurality of cameras to be affixed to the motor vehicle, the plurality of cameras collectively providing a set of views around the motor vehicle, each of the plurality of cameras providing a respective image,
b) at least one image recording device for recording images provided by at least one of the plurality of cameras; and
c) at least one monitoring device for viewing images recorded by the image recording device.
